(19) United States
(12) Patent Application Publication
(10) Pub. No.: US 2006/0051546 A1
(43) Pub. Date: Mar. 9, 2006

(54) Hybrid structural module

(75) Inventor: Gerardus Maria Van Erp, Toowoomba, Queensland (AU)

Correspondence Address: LEYDIG VOIT & MAYER, LTD, TWO PRUDENTIAL PLAZA, SUITE 4900, 180 NORTH STETSON AVENUE, CHICAGO, IL, 60601-6780, US

(73) Assignee: The University of Southern Queensland, Queensland (AU)

(21) Appl. No.: 10/534,938

(22) PCT Filed: Nov. 13, 2003
(86) PCT No.: PCT/AU03/01519

§ 371 Date: Jun. 16, 2005

(30) Foreign Application Priority Data
Nov. 13, 2002 (AU) 2002952618
Apr. 30, 2003 (AU) 2003902045

(51) Int. Cl. F16L 11/04

(52) U.S. Cl. 428/36.91; 264/31; 264/239

(57) ABSTRACT

A hybrid structural module (10) comprising a tubular fibre composite member (20), a filled resin system (30) located within said tubular fibre composite member, and at least one elongated steel member (40) located within the filled resin system, wherein the filled resin system binds the steel member and tubular member together.

### FIELD OF THE INVENTION

This invention relates to a hybrid structural module. In particular, the invention relates to a structural module that may be used as an advanced reinforcement element in structural members made of polymer or standard concrete or as an advanced building block in modular pultrusion structures.

### BACKGROUND OF THE INVENTION

Polymer concrete is made by polymerising a polymeric material with filler material such as aggregate (e.g. gravel, sand etc.). Polymer concrete has generally good durability and chemical resistance and is therefore used in various applications such as in pipes, tunnel supports, bridge decks and electrolytic containers. The compressive and tensile strength of polymer concrete is generally significantly higher than that of standard concrete. As a result polymer concrete structures are generally smaller and significantly lighter than equivalent structures made out of standard concrete.

However, polymer concrete still requires reinforcement as with standard concrete. This normally involves the use of traditional reinforcement bars that are placed with the concrete during the forming process. In a corrosive environment, traditional steel reinforcement is subject to corrosion and therefore has been increasingly replaced with fibre composite reinforcement.

The superior physical properties of fibre composites are well recognised. They combine high strength with low weight and have generally good durability and resistance to salts, acids and other corrosive materials, depending on the resin formulation. Based on these material characteristics, fibre composite reinforcement has a range of advantages over traditional steel reinforcement which is heavy and subject to corrosion. However, one of the major disadvantages of standard fibre composites reinforcement compared to steel is its low Modulus of Elasticity (stiffness). The latter is a problem in many civil engineering structures, which generally have very high stiffness requirements.

### OBJECT OF THE INVENTION

It is an object of the invention to overcome or alleviate one or more of the above disadvantages or provide the consumer with a useful or commercial choice.

It is the preferred object of this invention to enable structural elements to be produced that can be used as reinforcement elements in polymer concrete or normal concrete that have greatly improved corrosion and stiffness characteristics.

It is a further preferred object of the invention to allow structural elements with excellent corrosion resistance and high stiffness to be produced that can be used as advanced building blocks in modular pultruded structures.

It is a further preferred object of the invention to allow structural elements made of concrete and continuous fibre composite reinforcement to be produced cost effectively.

### SUMMARY OF THE INVENTION

In one form, although not necessarily the broadest or only form, the invention resides in a hybrid structural module comprising:

a tubular fibre composite member;

a filled resin system located within said tubular fibre composite member; and

at least one elongated steel member located within the filled resin system;

wherein the filled resin system binds the steel member and tubular member together.

Preferably, the tubular fibre composite member is a pultruded member. The pultruded member may be substantially square or slightly rectangular in transverse cross-section.

The internal void of the tubular member may be square, rectangular or circular.

The tubular fibre composite member may have the majority of its fibres orientated in a longitudinal direction.

The resin in the filled resin system could be a polyester, vinylester, polyurethane or epoxy resin. Preferably, the filled resin system is a filled epoxy system.

Preferably, the filled resin system has a low shrinkage rate. Preferably, the shrinkage rate is less than 4%. More preferably, the shrinkage rate is less than 2%.

Preferably, the filled resin system has high adherence to both the steel and the tubular fibre composite member.

The filled resin system may allow for high filler loadings (up to 70%) to be used without severely affecting the flowability of the filled resin system. Usually, the filler is inert. Preferably, the filler has a compression strength of between 20 MPa and 60 Mpa.

Preferably, the failure strain of the filled resin system is larger than the serviceability strain of a typical engineering structure. Usually, the failure strain of the filled resin system is between 0.5-1.0%, whilst the serviceability strain is typically between 0.1-0.2%.

The filled resin system may include a light aggregate and a heavy aggregate. The light aggregate may have a specific gravity less than that of the resin. The light aggregate can be any type of light aggregate, or combination of light aggregates, dependent on the desired structural and corrosion resistant properties of the filled resin system. Usually, the light aggregates have a specific gravity of 0.5 to 0.9. The light aggregates usually make up 20-25% by volume of the filled resin system. Preferably, the light aggregates are centre spheres. Preferably, the filler consists of centre spheres with a specific gravity of approximately 0.7, a nominal particle size range between 20-300 microns, and compression strength of approximately 40 MPa. Alternately, hollow glass microspheres with a similar specific gravity and volume may be used.

The heavy aggregate may have a specific gravity larger than that of the resin. The heavy aggregate may be any type of heavy aggregate, or combination of heavy aggregates, dependent on the desired structural and corrosion resistant properties of the filled resin system. The heavy aggregates usually make up 40-60% by volume of the filled resin system. Preferably, the heavy aggregate is basalt. Usually, the basalt is crushed. The crushed basalt may have a particle size 1 to 7 mm. Preferably, the basalt makes up between 40-50% by volume of the filled resin system. The basalt normally has a specific gravity of approximately 2.8. Alternately, sand that has a similar specific gravity as basalt may be used. Preferably, the sand makes up between 50-60% by volume of the filled resin system.

Preferably, the resin contains a thixotrope to keep the light aggregate in suspension.

The filled resin system of the present invention may also include fibrous reinforcement material to increase the structural properties of the filled resin system. The reinforcement material may be glass, aramid, carbon and/or thermo plastic fibres.

The steel member may be a round or deformed bar, threaded rod or tendon (cable). Preferably, the steel member is a high strength steel member with a yield strain of approximately 0.25%, and a failure strain in excess of 2%.

The steel member may be made of plain carbon steel, galvanised steel, or stainless steel.

The steel member may be slighter shorter than the length of the tubular fibre composite member so that the steel is located fully within the tubular member. These ends of the tubular member may be completely filled with the filled resin system in order to create a solid ‘block’ of corrosion protection for the steel member at both ends of the tubular member.

Alternatively, the steel member may extend outwardly from the tubular member and the resin system to allow the beam to be attached to other building components.

There may be a single steel member or multiple steel members located within the beam. If there are multiple steel members they may be spaced substantially an equal distance away from each other.

The steel member may be prestressed prior to the hybrid member being formed.

The dimensions of the steel member and the wall thickness of the tubular fibre composite member can be tailored to obtain specific predefined stiffness and/or strength characteristics.

In another form, the invention resides in a method of forming a hybrid structural module, the method including the steps of:

forming a tubular fibre composite member;

locating at least one longitudinal steel member within the tubular fibre composite member; and

locating a filled resin system within the tubular fibre composite member so the filled resin system binds the steel member and tubular member together.

The tubular fibre composite members may be sanded or abraded on the inside before the filled resin system is poured into the tubular member.

The steel member may be cleaned with a solvent and/or etched prior to the steel member being located within the tubular member.

The steel member may be lowered in the tubular fibre composite module and resin poured in the module to fill the void. Alternatively, the filled resin is poured into the tubular fibre composite member, and the steel member is lowered into the tubular fibre composite member.

### BRIEF DESCRIPTION OF THE DRAWINGS

Embodiments of the invention, by way of example only, will be described with reference to the accompanying drawing in which:

FIG. 1 is a perspective view of a hybrid structural member according to a first embodiment of the invention;

FIG. 2 is a perspective view of a hybrid structural module according to a second embodiment of the invention;

FIG. 3 is a perspective view of a hybrid structural module according to a third embodiment of the invention;

FIG. 4 is a transverse sectional view of a hybrid structural module according to a fourth embodiment of the invention; and

FIG. 5 is a transverse sectional view of a hybrid structural module according to a fifth embodiment of the invention.

FIG. 6 is a transverse sectional view of a hybrid structural module according to a sixth embodiment of the invention;

FIG. 7 is a transverse sectional view of a hybrid structural module according to a seventh embodiment of the invention;

Like numerals will be used to describe like components throughout the detailed description of the preferred embodiments.

### DETAILED DESCRIPTION OF THE PREFFERED EMBODIMENTS

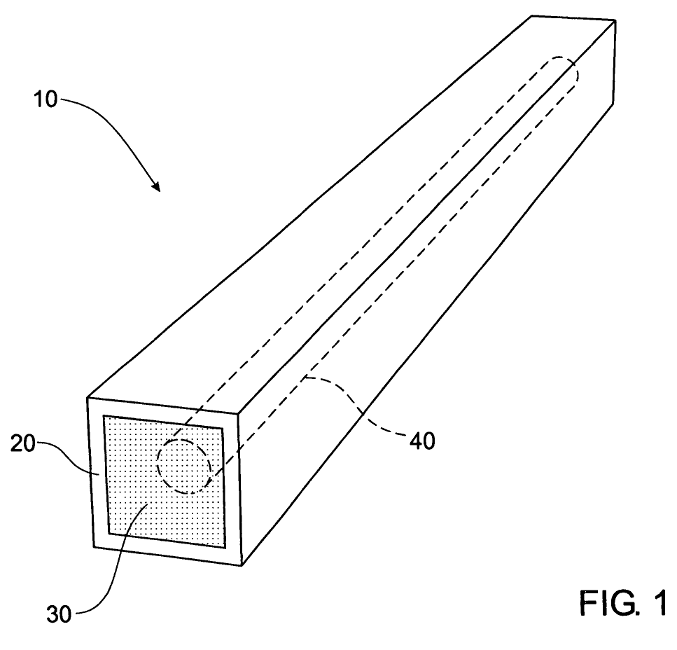

FIG. 1 shows a hybrid structural module 10 used as an advanced reinforcement element in structural members made of polymer concrete or normal concrete or as an advanced building block in modular pultrusion structures.

The hybrid structural module 10 is formed from a tubular fibre reinforced composite member 20, a filled resin system 30, and a steel reinforcement bar 40 as shown in FIG. 1.

The filled resin system fills the void between the steel bar and tubular fibre composite member and adheres to both the steel bar and inside of the tubular fibre composite member to make the steel bar and tubular fibre composite member work together as one structural unit. The filled resin system has a ‘custard-like’ consistency such that it easily flows in the void between the steel and the tubular fibre composite member without creating large air voids.

The tubular fibre composite member is a pultruded member that is substantially square in transverse cross-section. The cross-section dimensions of the tubular fibre composite member are 75 mm×75 mm. The length of the tubular fibre composite member is variable.

The filled resin system has very little shrinkage, less than 2%, in order not to create large internal stresses between the steel bar and tubular fibre composite member. Further, the low shrinkage of the filled resin system prevents cracking during the production of hybrid structural modules. Any cracks could allow moisture or other corrosive liquids to reach the steel bar which is undesirable. The filled resin system has high adherence to both the steel bar and the tubular fibre composite member.

The resin in the filled resin system is a filled epoxy system. The filler consists of centre-spheres with a nominal particle size range between 20-300 microns and a strength of approximately 40 MPa. The filler in the filled resin system allows for high filler loadings (up to 45%) to be used without severely affecting the flowability of the filled resin system. These high filler loadings significantly reduce the overall shrinkage of the filled resin system. The 1.0% failure strain of the filled resin system is significantly larger than the serviceability strain of approximately 0.2% of a typical structural member. The large difference in serviceability strain level and failure strain for the filled resin system significantly reduces the chance of cracking of the filled resin system under sustained dynamic loading at serviceability level.

The hybrid structural module is produced by first abrading the inside of the tubular fibre composite member to increase the adhesion between the filled resin system and the fibre composite member. The steel bar is cleaned with a solvent to increase the adhesion between the fibre member and the steel bar.

The steel bar is lowered in the tubular fibre composite module and resin is poured in the module to fill the void.

The steel bar provides the stiffness, the tubular fibre composite member provides a corrosion protective shell for the steel member together with extra strength and stiffness, and the filled resin system binds the steel bar and tubular fibre composite member together, and provides an additional thick layer of corrosion protection to the steel.

The tubular fibre composite member has the large majority of its fibres in longitudinal direction. This results in a thermal coefficient of expansion in the tubular fibre composite member that is comparable to that of the steel bar. Furthermore, having the large majority of the fibres in longitudinal direction results in the operating strains under serviceability conditions (generally between 0.16%-0.2%) to be optimal in both the tubular fibre composite member and the steel bar.

The steel bar is a high strength steel bar with a yield strain of approximately 0.25% and a failure strain in excess of 2%. Yielding of the steel bar ensures that the tubular fibre composite member reaches its failure strain (generally between 1.3%-2%) before the steel bar reaches its failure strain. The tubular composite member and the steel bar contribute fully to the ultimate load carrying capacity of the hybrid structural member.

Due to the yielding of the steel, the hybrid member has a ductile behaviour despite the rather brittle nature of the tubular fibre composite member. Furthermore, by combining the steel bar, the filled resin system and the tubular fibre member, each having a different failure behaviour, redundancy is built into the hybrid structural element. It is extremely unlikely for the steel bar, filled resin system and tubular fibre member to fail at the same time. Therefore, if one of the steel bar, filled resin system or tubular fibre composite member fails, there is always the other that does not fail that offers an alternative load carrying capacity.

In addition, cracks in one of the steel bar, filled resin system or tubular fibre composite member is unlikely to extend into the other of the steel bar, filled resin system or tubular fibre composite member, as cracks have a tendency to follow the interface of different materials rather than travelling straight through them. Furthermore, it is well known that fibres in the tubular fibre composite member and the filler in a filled resin system act as crack arresters, thereby increasing the crack resistance of the hybrid structural module under fatigue and other loading.

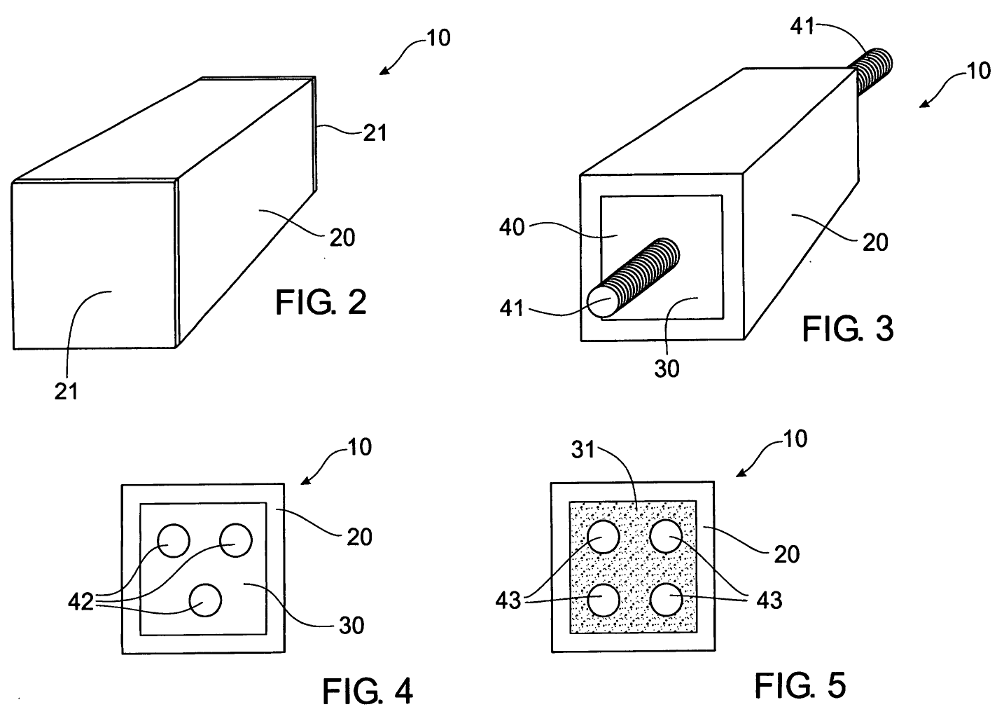

FIG. 2 shows a second embodiment of a hybrid structural module 10 in which blocks 21 of fibre-reinforced plastic seal the ends of the hybrid structural module 10. The blocks prevent water from contacting the filled resin system and steel bar to prevent corrosion,

FIG. 3 shows a third embodiment of a hybrid structural module 10 in which the steel bar 40 has threaded ends 41. The threaded ends 41 allow the hybrid structural module to be attached using standard fasteners when the hybrid structural module is used in construction.

Further, the steel bar 40 is pre-stressed prior to the formation of the hybrid structural member 20.

FIG. 4 shows a fourth embodiment of a hybrid structural member in which the single steel bar 40 has been replaced by three steel bars 42.

FIG. 5 shows a fifth embodiment of the hybrid structural module that is capable of carrying high compression loads. In this embodiment, the filled resin system 31 has been varied to be formed with approximately 28% by volume of resin, 22% by volume of light aggregate, and 50% by volume of heavy aggregate. The aggregate contributes significantly to the compression capacity of the hybrid module.

The light aggregate is in the form of centre spheres having a specific gravity of approximately 0.7. The heavy aggregate is formed from crushed basalt having a specific gravity of approximately 2.8 and a particle size of 1-7 mm.

The light aggregate has a specific gravity that is slightly less than that of the resin, whilst the heavy aggregate has a specific gravity that is larger than that of the resin.

A thixotrope is added to the resin so that the light aggregate will stay in suspension within the resin. Consequently, the resin together with the lighter aggregate in suspension becomes a flowable filled resin system in its own right. The amount of the lighter aggregate suspended in the resin can be varied as required. To obtain an economical polymer concrete formulation, the lighter aggregate is approximately 45% by volume of the flowable filled resin mix.

Four steel bars 43 are located within the filled resin system 31, and the hybrid structural module is formed the same as described previously.

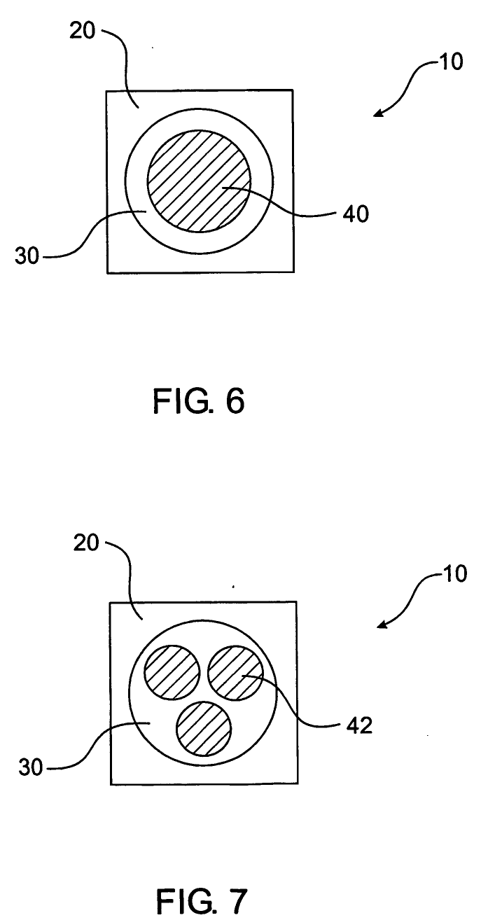

FIG. 6 shows sixth embodiment of a hybrid structural module in which an internal shape of the tubular fibre member is substantially cylindrical. In this embodiment, the internal surface of the tubular member can be abraded easily, due to its cylindrical shape, before the filled resin system is introduced into the tubular member.

FIG. 7 shows a similar embodiment to that show in FIG. 6 except that three steel bars are utilised instead of a single steel bar.

It should be appreciated that various other changes and modifications, such as the mixture of the filled resin system, the number of steel members and size of the tubular member, may be made to the embodiments described without departing from the spirit or scope of the invention.

1. A hybrid structural module comprising:
a tubular fibre composite member;
a filled resin system located within said tubular fibre composite member; and
at least one elongated steel member located within the filled resin system;
wherein the filled resin system binds the steel member and tubular member together.

2. The hybrid structural module of claim 1 wherein the tubular fibre composite member is a pultruded member.

3. The hybrid structural module of claim 2 wherein the pultruded member is rectangular or square in transverse cross-section.

4. The hybrid structural module of claim 1 wherein an internal void of the tubular member is square, rectangular or circular.

5. The hybrid structural module of claim 1 wherein the tubular fibre composite member has the majority of its fibres orientated in a longitudinal direction.

6. The hybrid structural module of claim 1 wherein the resin in the filled resin system is a polyester, vinylester, polyurethane or epoxy resin.

7. The hybrid structural module of claim 1 wherein the filled resin system adheres to both the steel and the tubular fibre composite member.

8. The hybrid structural module of claim 1 wherein a filler of the filled resin system is inert.

9. The hybrid structural module of claim 1 wherein a filler of the filled resin system has compression strength of between 20 MPa and 60 Mpa.

10. The hybrid structural module of claim 1 wherein the filled resin system includes a light aggregate and a heavy aggregate.

11. The hybrid structural module of claim 10 wherein the light aggregate has a specific gravity less than that of the resin.

12. The hybrid structural module of claim 10 wherein the light aggregate has a specific gravity of 0.5 to 0.9.

13. The hybrid structural module of claim 10 wherein the light aggregate makes up 20-25% by volume of the filled resin system.

14. The hybrid structural module of claim 10 wherein the light aggregate is centre spheres.

15. The hybrid structural module of claim 14 wherein the centre spheres have a specific gravity of approximately 0.7, a nominal particle size range between 20-300 microns, and compression strength of approximately 40 MPa.

16. The hybrid structural module of claim 10 wherein the light aggregate is hollow glass micro spheres.

17. The hybrid structural module of claim 10 wherein the heavy aggregate has a specific gravity larger than that of the resin.

18. The hybrid structural module of claim 10 wherein the heavy aggregate usually makes up 40-60% by volume of the filled resin system.

19. The hybrid structural module of claim 18 wherein the heavy aggregate is basalt.

20. The hybrid structural module of claim 19 wherein the basalt has a particle size of between 1 to 7 mm.

21. The hybrid structural module of claim 19 wherein the basalt makes up to between 40-50% by volume of the filled resin system.

22. The hybrid structural module of claim 19 wherein the basalt has a specific gravity of approximately 2.8.

23. The hybrid structural module of claim 10 wherein the resin contains a thixotrope.

24. The hybrid structural module of claim 1 wherein the steel member is a round or deformed bar, threaded rod or tendon (cable).

24. The hybrid structural module of claim 1 wherein the steel member has a yield strain of approximately 0.25%, and a failure strain in excess of 2%.

25. The hybrid structural module of claim 1 wherein the steel member is plain carbon steel, galvanised steel, or stainless steel.

26. The hybrid structural module of claim 1 wherein the steel member is slighter shorter than the length of the tubular fibre composite member.

27. The hybrid structural module of claim 1 wherein the tubular member is completely filled with the filled resin system.

28. The hybrid structural module of claim 1 wherein the steel member is totally encompassed by the filled system.

29. The hybrid structural module of claim 1 wherein the steel member extends outwardly from the tubular member and the resin system.

30. The hybrid structural module of claim 1 wherein there are multiple steel members.

31. The hybrid structural module of claim 30 wherein the multiple steel members are spaced substantially an equal distance away from each other.

32. The hybrid structural module of claim 1 wherein the steel member is prestressed prior to the hybrid member being formed.

33. A method of forming a hybrid structural module, the method including the steps of:
forming a tubular fibre composite member;
locating at least one longitudinal steel member within the tubular fibre composite member; and
locating a filled resin system within the tubular fibre composite member so the filled resin system binds the steel member and tubular member together.

34. The method of claim 33 wherein an internal void of the tubular fibre composite members of claim 33 is sanded or abraded before filled resin system is located within the tubular member.

35. The method of claim 33 wherein the steel member is cleaned with a solvent and/or etched prior to the steel member being located within the tubular member.

36. The method of claim 33 wherein the steel member is lowered into the tubular fibre composite module and resin is poured into the module to fill the void.

37. The method of claim 33 wherein the filled resin is poured into the tubular fibre composite member, and the steel member is lowered into the tubular fibre composite member.
